(19) United States
(12) Patent Application Publication
(10) Pub. No.: US 2022/0040941 A1
(43) Pub. Date: Feb. 10, 2022

(54) YARD CONTROL

(71) Applicant: ams Sensors Singapore Pte. Ltd., Singapore (SG)

(72) Inventors: Sonja Gantner, Lachen (CH); Tobias Senn, Zurich (CH); Robert Lenart, Zurich (CH); Alexander Bietsch, Thalwil (CH)

(21) Appl. No.: 17/414,529

(22) PCT Filed: Dec. 17, 2019
(86) PCT No.: PCT/SG2019/050617

§ 371 Date: Jun. 16, 2021

Related U.S. Application Data
(60) Provisional application No. 62/785,500, filed on Dec. 27, 2018.

(51) Int. Cl. B29D 11/00

(52) U.S. Cl. CPC B29D 11/0048; B29D 11/00307

(57) ABSTRACT

A method of manufacturing a plurality of optical elements comprising the steps of providing a substrate (120) providing a tool (100) comprising, a plurality of replication sections (106) each defining a surface structure of one of the optical elements, and at least one contact spacer portion (112), aligning the tool (100) and the substrate (120) with respect to each other and bringing the tool (100) and a first side of the substrate (120) together, with replication material (124) between the tool (100) and the substrate (120), the contact spacer portion (112) contacting the first side of the substrate (120), hardening the replication material (124), and separating the tool (100) from the substrate (120) with the hardened replication material adhering to the substrate (120), wherein the tool (100) has yard line features (304) around at least a portion of the replication sections (106), the yard line features (304) configured to contain the replication material (124) on a first side of the yard line with respect to both the tool (100) and the substrate (120).

### TECHNICAL FIELD

This invention relates to yard control features during epoxy jetting.

### BACKGROUND

Optical devices that include one or more optical radiation emitters and one or more optical sensors can be used in a wide range of applications including, for example, distance measurement, proximity sensing, gesture sensing, and imaging. Small optoelectronic modules such as imaging devices and light projectors employ optical assemblies that include lenses or other optical elements stacked along the device's optical axis to achieve desired optical performance. Replicated optical elements include transparent diffractive and/or refractive optical elements for influencing an optical beam. In some applications, such optoelectronic modules can be included in the housings of various consumer electronics, such as mobile computing devices, smart phones, or other devices.

### SUMMARY

The present disclosure describes optical and optoelectronic assemblies that include micro-spacers, as well as methods for manufacturing such assemblies.

A method of manufacturing a plurality of optical elements comprising the steps of providing a substrate providing a tool comprising, a plurality of replication sections each defining a surface structure of one of the optical elements, and at least one contact spacer portion, aligning the tool and the substrate with respect to each other and bringing the tool and a first side of the substrate together, with replication material between the tool and the substrate, the contact spacer portion contacting the first side of the substrate, hardening the replication material, and separating the tool from the substrate with the hardened replication material adhering to the substrate, wherein the tool has yard line features around at least a portion of the replication sections, the yard line features configured to contain the replication material on a first side of the yard line with respect to both the tool and the substrate.

Yard control features as described herein advantageously enable the creation of densely packed layouts with non-circular lenses, and modules where optical structures and mechanical (e.g., spacers) or electrical functionality (e.g., bond pads) are combined. Other advantages include generating a venting channel on a substrate without an additional dicing step during replication and stacking. The features can be used to generate more dense layouts, create packages including eye safety features, and reduce process steps for venting channel generation. The features avoid uncontrolled epoxy flow and formation of air bubbles, allowing densely packed structures and reducing production costs.

The substrate may be a “wafer”, or other base element, with an additional structure added to it, for example with a hardened replication material structure adhering to it, defining a surface of the plurality of optical elements, with some lithographically added or removed features (such as apertures etc.) or with some other structure. The substrate may comprise any material or material combination.

The optical elements may be any elements influencing light that is irradiating them including but not restricted to lenses/collimators, pattern generators, deflectors, mirrors, beam splitters, elements for decomposing the radiation into its spectral composition, etc., and combinations thereof. Both a replicated structure on one side of a substrate, and an ensemble of two aligned replicated optical elements on two sides of a substrate are called an “optical element”.

The tool (or “replication tool”) may comprise a first, hard material forming a rigid back plate and a second, softer material portion (replication portion) that forms both the contact spacer portion(s) and the replication sections. Generally, the contact spacer portion(s) may be of the same material as the portion of the tool that forms the replication sections, and may merely be structural features of the tool (not added elements). As an alternative, the contact spacer portions may comprise an additional material, for example a coating of a soft and/or adhesive material on an outermost surface.

As an alternative to a low stiffness material like PDMS, the contact spacers may also comprise an adhesive, for example an adhesive layer. Using a low stiffness material for the entire replication portion of the tool is advantageous regarding its manufacturing, as no separate step for adding the contact spacers or a coating thereof is required. The entire replication portion may be manufactured in a single shape by replicating (molding, embossing etc.) from a master or sub-master that also includes the contact spacer portion(s).

The contact spacer portions are operable to rest against the substrate during replication, with no material between the contact spacer portions and the substrate. The contact spacer portions may be contiguous or may comprise a plurality of discrete portions around the periphery or distributed over a large portion of the periphery and/or an interior of the replication surface. In other words, the contact spacer portion(s) may be in any configuration that allows the replication tool to rest against the substrate. For example, the distribution of the contact spacer portion(s) is such that contact spacer portion(s) are on both sides of every in-plane line through the center of mass of the tool. The spacers are arranged and configured such that if the tool lies on the substrate, the thickness (the z-dimension perpendicular to the substrate and tool plane) is defined by the spacer portions.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 illustrates an example cross sectional tool/substrate structure for replication.

FIG. 2 is a replicated structure with poor line features from uncontrolled epoxy flow leading to air bubble formation during replication.

FIG. 3 illustrates a cross sectional tool/substrate structure with yard line features to control epoxy flow.

FIG. 4 shows details of replicated structures replicated with yard line features such as in FIG. 3.

Like reference symbols in the various drawings indicate like elements.

### DETAILED DESCRIPTION

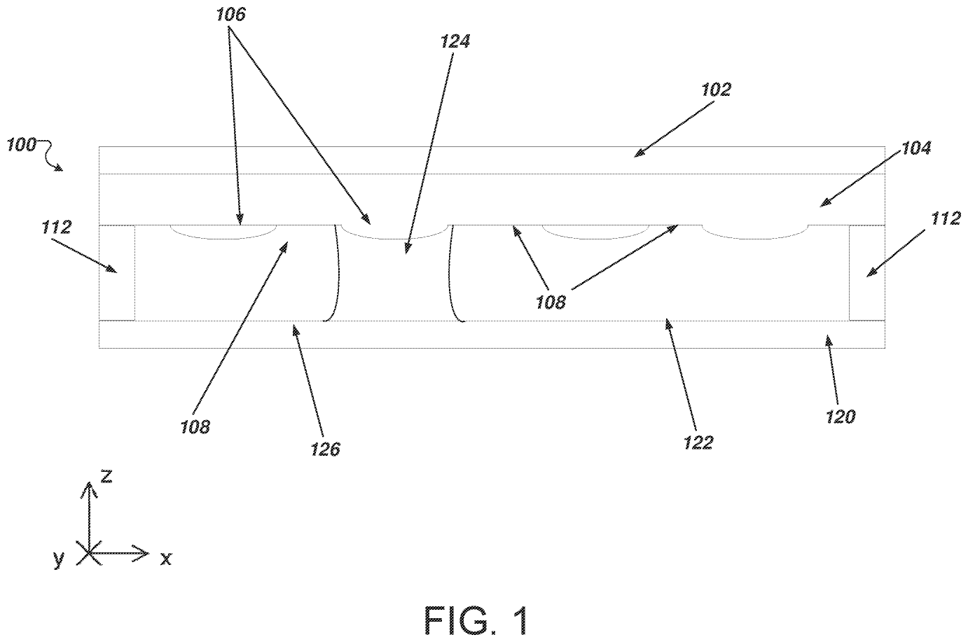

FIG. 1 schematically shows a cross section through a tool 100 and a substrate 120. The tool 100 in the shown embodiment comprises a rigid backplate 102 of a first material, for example glass, and a replication portion 104 of a second, softer material, for example PDMS. The replication portion forms a replication surface 108 comprising a plurality of replication sections 106, the surface of each of which is a (negative) copy of a surface shape an optical element to be manufactured. The replication sections 106 can be convex and thus define a concave optical element surface, or be convex and define a concave optical element surface.

The replication portion 104 has contact spacer portions 112 that are illustrated as arranged peripherally. The contact spacer portions 112 are the structures of the replication tool 100 that protrude the furthest into the z direction. The contact spacer portions are essentially flat and, thus, are operable to rest against the substrate 102 during replication, with no material between the contact spacer portions 112 and the substrate 120. The contact spacer portions 112 may, for example, form a ring around the periphery of the replication surface 108, may comprise a plurality of discrete portions around the periphery, or it may comprise a plurality of discrete portions distributed over a large portion of the periphery and/or an interior of the replication surface 108.

The substrate 120 has a first side (e.g., substrate surface 126) and a second side and can be any suitable material, for example glass. The substrate 120 further has a structure added to it to which the replica is to be aligned. The structure may, for example, comprise a coating 122 structured in the x-y-plane, such as a screen with apertures, or a structured IR filter, or electrical layers (Cr, ITO, Au . . . ), etc. The structure may in addition, or as an alternative, comprise further features like markings etc. Further, or as another alternative, the structure may comprise a hardened replication material structure constituting a surface of the optical elements.

For replicating the replication surface 108 of the tool 100, replication material 124 is applied to the substrate 120 or the tool 100 or both the tool 100 and the substrate 120. Such application of replication material 124 may include application of a plurality of portions of replication material 124, one portion for each of the replication sections, to the tool 100 and/or the substrate 120 (although a single portion of replication material 124 is illustrated in the figure). Each portion may, for example, be applied by squirting or jetting one droplet or a plurality of droplets, by a dispensing tool that may for example work in an inkjet-printer-like manner. Each portion may optionally consist of a plurality of sub-portions that come into contact with each other only during replication. Generally, the droplets are of epoxy.

After application of the replication material 124, the substrate 120 and the tool 100 are aligned with respect to each other. To this end, a process similar to the one used in so-called mask aligners may be used. The alignment process may include aligning at least one particular feature (preferably two features are used) of the tool 100 and/or of the substrate 120 with at least one particular feature of the substrate 120 or the tool 100, respectively, or with a reference point of an alignment device. Suitable features for this include well-defined elements of the structure itself (such as a defined corner of a structured coating or a lens peak etc.), specifically added alignment marks, or possibly also edges etc. of the base element etc. Alignment also includes, as is known in the art, precisely making parallel the tool and substrate surfaces to avoid wedge errors; such parallelization may take place prior to the x-y-alignment.

Subsequent to the alignment, the substrate 120 and the tool 100 are brought together, with the contact spacer portions 112 resting against the substrate surface and defining (if present, together with the floating spacers) the z dimension and also locking the tool against x-y-movements. Thereafter, the substrate-tool-assembly is removed from the alignment station and transferred to a hardening station.

The replication portion 104 of the tool, or at least a surface of the contact spacer portions 112, is made of a material with a comparably low stiffness so that it can, under “normal” conditions where for example no more pressure than the one caused by gravity forces of the tool lying on the substrate or vice versa, adapt to roughnesses on a micrometer and/or sub-micrometer scale and, thus, may form an intimate connection to the substrate surface. In addition, the replication portion of the tool or at least the surface of the contact spacer portion may have a comparably low surface energy to make such adaptation to roughnesses on a micrometer and/or sub-micrometer scale favorable. A preferred example of such a material is polydimethylsiloxane PDMS.

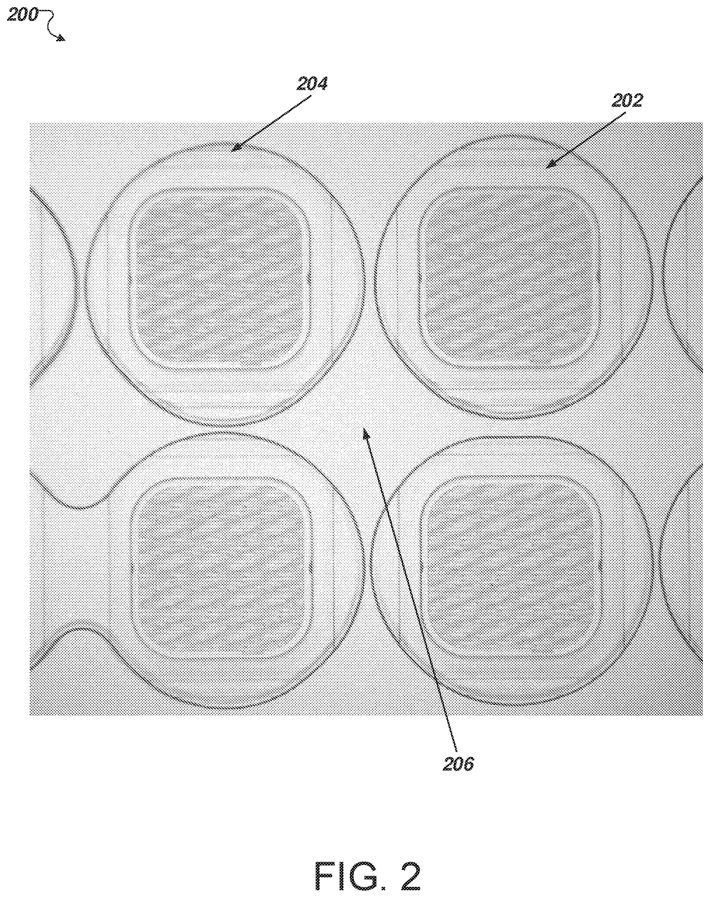

Referring to FIG. 2, in replication, excess epoxy 202 (e.g., the replication material 124) applied during jetting normally overflows the region of interest and forms a yard 204 when the tool 100 and the substrate 100 (e.g., glass) are brought into contact. The yard 204 is typically a circle shape, as shown. This circular yard 204 results from additional epoxy 202 being added during the replication process than each structure requires, causing an overflow. The additional epoxy 202 ensures that the complete volume of replication material needed for a particular structure is available (as the tolerance of the epoxy volume is not zero), and the extra fluid pools to form the yard 204.

In dense layouts, these circular yards 204 can connect and form undesirable air pockets 206 by trapping air between the circles. The position of the air pockets 206 cannot be controlled and can cause structures to not be fully covered, leading to yield loss. In modules where stacking is required, uncontrolled epoxy flow during replication can lead to the requirement of an additional dicing step to include venting channels during stacking.

To control epoxy flow during replication, yard line features (also called “yard lines,” “line features,” or “yard line features”) can be included in the tool 100 design to change the local fluidic forces and give the epoxy 202 a preferred flow direction. Such features can be included in the mastering process itself (during laser writing) or can be added afterwards in a lithomold process where the features can be structured into an additional layer of epoxy. The yard line features described herein can be integrated in all kind of masters fabricated by different technologies (EBL, laser writer, etc.).

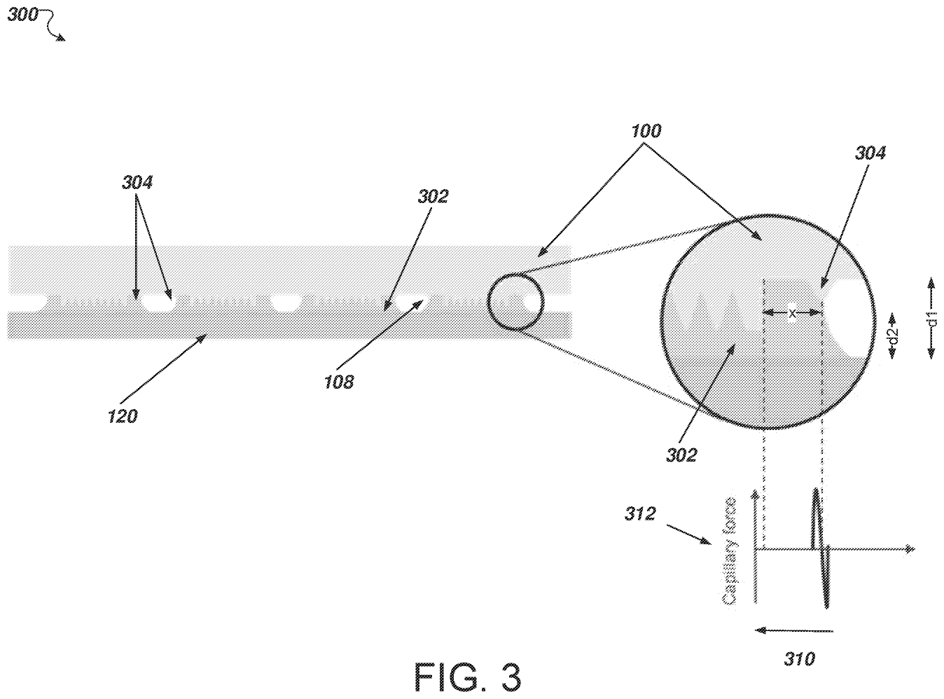

FIG. 3 shows yard lines 304 that will avoid the flow of liquid epoxy 302 (e.g., the replication material 124) that forms a yard 204 into a circle shape. Instead, the line features 304 cause the liquid epoxy 302 to follow the yard line 304 at the moment the liquid epoxy 302 makes contact with the yard line 304. The line features 304 in some instances are etched (or otherwise fabricated) in the tool 100 on its replication surface 108 and/or the line features 304 can be present on the substrate 120 either alternatively or additionally.

The yard lines 304 generate a local change in the capillary force. Capillary action is the ability of a liquid to flow in narrow spaces without the assistance of, or even in opposition to, external forces like gravity; in this instance the narrow space is between the tool 100 (specifically the yard line 304) and the substrate 120.

Local changes in the capillary force alter the preferred direction of the liquid epoxy 302 flow. Referring to FIG. 3, an exemplary yard line 304 reduces the distance between the tool surface 108 and the surface of the substrate 126 from distance d1 to distance d2, changing the contact angle between the liquid and the air outside of the yard line 304. This physical change causes the capillary force to rapidly change in a highly local manner (as depicted in graph 312), consequently urging the liquid epoxy 302 to stay within of the yard line 304 (e.g., directed towards the inside of the structure as shown by the arrow 310). The yard line 304 reduces the separation distance to d2, causing the liquid epoxy 302 to be contained and not spread out. The shape of the yard line 304 (e.g., its angle and the height d2) can be chosen to contain a maximum volume of liquid epoxy 302, e.g., a maximum epoxy volume that cannot overcome the capillary force present for a particular yard line 304 configuration. Although triangular yard line features 304 are shown, the features could be any shape that reduces the separation distance between the tool 100 and the substrate 120, e.g. a rectangular or square step, a curved line, or an irregular shape.

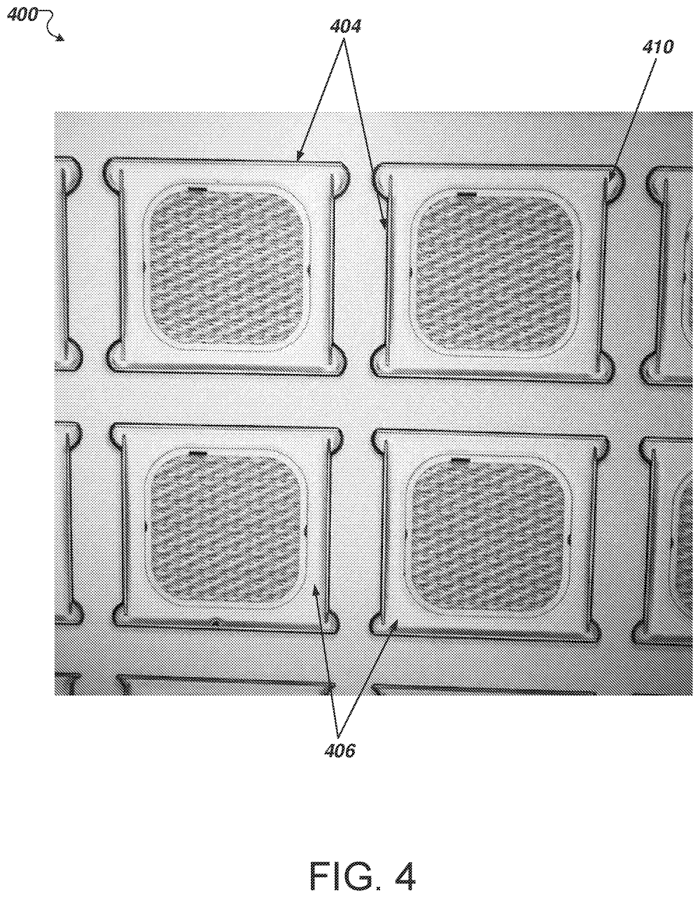

FIG. 4 shows a substrate 400 that has been manufactured using yard line features 304. The yard line structures 404 resulting from the replication process with yard lines 304 creates the generally square yards 406 shown. That is, the yard lines 304 (shown in FIG. 3) are configured in a generally square shape. When the liquid epoxy 302 is jetted during the normal replication process, the yard lines 304 cause the liquid epoxy 302 to not pass beyond the yard lines 304. The result is the illustrated square yard shapes 406 that are bounded by the yard line structures 404. Although square yards 406 are shown, the epoxy yards resulting from the yard lines 304 could be any shape, e.g. could be irregular shape. For example, the example substrate 400 has irregular corners 410 that are part of the square yards 406. These irregular corners 410 can be design features for the completed optical element.

In some embodiments, yard lines 304 can be used to exclude liquid epoxy 302 from a portion of a substrate 120 rather than to keep it within a desired portion of the substrate 120. For example, areas of a substrate may be intentionally kept clean, such as bond pads or electrical contacts for eye safety features. The areas to be kept clean can be encircled by a yard line 304, in any desired shape.

As mentioned above, dicing may be carried out at some stage subsequent to the above-mentioned method steps for aligned replication. The substrate with the replica(s) adhering to it is divided or diced into the individual optical elements. This step may be necessary to vent air bubbles (e.g., air bubble 206 in FIG. 2) With the yard technology described by the yard lines 304 this dicing step can be eliminated.

Yard control features as described herein advantageously enable the creation of densely packed layouts with non-circular lenses, and modules where optical structures and mechanical (e.g., spacers) or electrical functionality (e.g., bond pads) are combined. Other advantages include generating a venting channel without an additional dicing step during replication and stacking. The features can be used to generate more dense layouts, create packages including eye safety features, and reduce the number of process steps by venting channel generation.

A number of embodiments of the invention have been described. Nevertheless, it will be understood that various modifications may be made without departing from the spirit and scope of the invention. Accordingly, other embodiments are within the scope of the following claims.

What is claimed is:

1. A method of manufacturing a plurality of optical elements comprising the steps of:
providing a substrate;
providing a tool comprising, on a replication side, a plurality of replication sections, each replication section defining a surface structure of one of the optical elements, the tool further comprising at least one contact spacer portion, the contact spacer portion protruding, on the replication side, further than an outermost feature of the replication sections;
aligning the tool and the substrate with respect to each other and bringing the tool and a first side of the substrate together, with replication material between the tool and the substrate, the contact spacer portion contacting the first side of the substrate, and thereby causing the spacer portion to adhere to the first side of the substrate;
hardening the replication material; and
separating the tool from the substrate with the hardened replication material adhering to the substrate, wherein the tool has yard line features around at least a portion of the replication sections, the yard line features configured to contain the replication material on a first side of the yard line with respect to both the tool and the substrate.

2. An apparatus for manufacturing a plurality of optical elements comprising:
a substrate; and
a tool comprising, on a replication side, a plurality of replication sections, each replication section defining a surface structure of one of the optical elements, the tool further comprising at least one contact spacer portion, the contact spacer portion protruding, on the replication side, further than an outermost feature of the replication sections, wherein the tool has yard line features around at least a portion of the replication sections, the yard line features configured to contain the replication material on a first side of the yard line with respect to both the tool and the substrate.
